(19) United States
(12) Patent Application Publication
(10) Pub. No.: US 2026/0019758 A1
(43) Pub. Date: Jan. 15, 2026

(54) METHOD FOR OPERATING A HEARING DEVICE, AND HEARING DEVICE

(71) Applicant: Sivantos Pte. Ltd., Singapore (SG)

(72) Inventor: Michael MÜLLER, Erlangen (DE)

(21) Appl. No.: 19/263,798

(22) Filed: Jul. 9, 2025

(30) Foreign Application Priority Data
Jul. 9, 2024 (DE) 10 2024 206 480.7

(51) Int. Cl. H04R 25/00

(52) U.S. Cl. CPC H04R 25/507; H04R 25/43; H04R 2225/41; H04R 2225/43

(57) ABSTRACT

A method for operating a hearing device which has a neural network having a plurality of neurons to which a weighting vector with binary weights is in each case assigned. An input vector with binary values is fed to each neuron and is processed with the weighting vector in order to obtain a transfer function. The transfer function is processed with an activation function in such a way that a binary result is provided. There is also described a method for training the neural network, and a hearing device that is configured for carrying out the methods.

### CROSS-REFERENCE TO RELATED APPLICATION

This application claims the priority, under 35 U.S.C. § 119, of German Patent Application DE 10 2024 206 480.7, filed Jul. 9, 2024; the prior application is herewith incorporated by reference in its entirety.

### FIELD AND BACKGROUND OF THE INVENTION

The invention relates to a method for operating a hearing device with a neural network. The invention further relates to a method for training a neural network, and to a hearing device.

Persons suffering from a loss of hearing normally use a hearing aid. An ambient sound is thereby captured by means of an electromechanical sound transducer. The electrical (audio) signals produced on the basis of the ambient sound are amplified by means of an amplifier circuit and are introduced into the auditory canal of the person by means of a further electromechanical transducer in the form of a receiver. Furthermore, the captured audio signals are usually processed, for which purpose a signal processor of the amplifier circuit is normally used. The amplification is attuned here to any hearing loss of the hearing aid wearer, who is also referred to below as the user or wearer.

Depending on the current situation, it may be necessary to modify the processing in order to achieve better comprehensibility for the user. Particularly in the case of speech, it is desirable to choose different processing methods for different syllables or sounds. Thus, for example, reduction in the case of specific frequencies results in improved comprehensibility in the case of some syllables, whereas, in the case of other syllables, this results in reduced comprehensibility.

One difficulty with this processing lies in the distinction between speech components and interfering noise components in the signal processed by the hearing device. Artificial neural networks (referred to below simply as neural networks) are particularly suitable for solving this problem. Neural networks having feedforward components, in which only the current input values influence the state, and also recurrent components, in which the state is also influenced by the result of past processing steps, are particularly suitable for processing audio signals. However, very large networks having many layers are required to ensure that neural networks are suitable for distinguishing between speech components and interfering noise components in the signal, i.e. the networks consist of a large number of neurons. This applies equally to other typical applications of neural networks for audio signal processing. Due to their size, these neural networks have a substantial hardware and energy requirement, which is undesirable for a hearing device, since a hearing device is intended to be as compact and energy-saving as possible.

### SUMMARY OF THE INVENTION

It is accordingly an object of the invention to provide a method for operating a hearing device which overcomes the above-mentioned and other disadvantages of the heretofore-known devices and methods of this general type and which provides for a particularly suitable method for operating a hearing device, a particularly suitable method for training a neural network, and also a particularly suitable hearing device, wherein, in particular, user comfort is increased, and wherein hardware resources and/or energy requirements are appropriately reduced.

With the above and other objects in view there is provided, in accordance with the invention, a method of operating a hearing device, the hearing device having a neural network with a plurality of neurons each having a weighting vector with binary weights assigned thereto, the method comprising:
feeding an input vector having binary values to each neuron of the neural network and processing the input vector with the weighting vector in order to obtain a transfer function; and
processing the transfer function with an activation function to provide a binary result.

In other words, the method serves to operate a hearing device. By way of example, the hearing device may be or includes a headphone, and the hearing device may be a headset. However, the hearing device is particularly preferably a hearing aid. The hearing aid serves to support a person suffering from a loss of hearing. In other words, the hearing aid is a medical device, by means of which, for example, a partial loss of hearing is compensated. The hearing aid is, for example a “receiver-in-the-canal” (RIC) hearing aid, an “in-the-ear” (ITE) hearing aid, an “in-the-canal” (ITC) hearing aid or a “complete-in-canal” (CIC) hearing aid. Alternatively, the hearing aid may be a “behind-the-ear” (BTE) hearing aid, which is worn behind an earlobe.

The hearing device is provided and configured to be worn on the human body. In other words, the hearing device preferably comprises a holding device by means of which it can be attached to the human body. Insofar as the hearing device is a hearing aid, the hearing device is provided and configured to be arranged, for example, behind the ear or inside an auditory canal. In particular, the hearing device is wireless and is provided and configured to be introduced at least partially into an auditory canal.

The hearing device preferably comprises a microphone which serves to capture sound. In particular, an ambient sound, i.e. sound waves, or at least a part thereof, is captured by means of the microphone during operation. The microphone is appropriately arranged at least partially inside a housing of the hearing device and is therefore at least partially protected. The microphone is suitably an electromechanical sound transducer. The microphone has, for example, only a single microphone unit or a plurality of microphone units that interact with one another. Each of the microphone units appropriately has a diaphragm that is set into vibration by sound waves, wherein the vibrations are converted into an electrical signal by means of a corresponding capture device, such as a magnet, which is moved in a coil. Alternatively, the microphone units are designed as capacitive, exploiting the fact that an applied electrical voltage changes when the distance between the membrane and a static surface of the microphone unit changes. The electrical voltage is applied, in particular, between the membrane and the static surface. The microphone units are preferably designed as omnidirectional. In this way or in another way, it is at least possible by means of the microphone to generate or at least provide an audio signal that is based on the sound incident on the microphone, i.e., in particular, the ambient sound.

The hearing device appropriately has a receiver for outputting an output signal. The output signal here is, in particular, an electrical signal, and is designed, for example, as digital or suitably as analog. The receiver is preferably an electromechanical sound transducer, for example a loudspeaker. Depending on the design of the hearing device, the receiver in its intended state is arranged at least partially inside or is at least acoustically connected to an auditory canal of a user of the hearing device, i.e. a person, who is also referred to as the wearer, user or hearing device wearer. In particular, the hearing device serves primarily to output the output signal by means of the receiver, wherein a corresponding sound is produced. In other words, the main function of the hearing device is preferably to output the output signal.

The hearing device suitably comprises a signal processing unit providing a signaling connection between any microphone and any receiver. The hearing device appropriately has a signal processor which, for example, forms the signal processing unit or at least a component thereof. The signal processor is, for example, a digital signal processor (DSP) or is implemented by means of analog components. In particular, the audio signal produced by the microphone is adapted by means of the signal processor or at least the signal processing unit so that the output signal is preferably produced. The signal processing unit is at least suitable and, in particular, is provided and configured, for this purpose. An A/D converter is appropriately arranged between the microphone and the signal processing unit, for example the signal processor, insofar as the signal processor is designed as a digital signal processor. In addition, the hearing device particularly preferably comprises an amplifier, or the amplifier is formed at least partially by means of the signal processing unit. The amplifier is connected, for example, upstream or downstream of the signal processor for signaling purposes.

The hearing device further comprises a neural network. The neural network is an artificial neural network. The neural network has a plurality of neurons.

The neurons are, in particular, divided among different layers which are arranged successively. A weighting vector comprising different weights is assigned to each neuron. The number of weights is, in particular, equal to or greater than the number of neurons of any respective upstream layer here. In particular, the weighting vectors, which are assigned to neurons of different layers, have a different number of weights here. The weights are designed as binary. Only two different configurations therefore occur for each weight, for example 0 (zero) and 1, or particularly preferably −1 and 1. The two possible configurations of the weight therefore differ from one another only in terms of the sign. It is consequently possible to represent each weight by means of a single bit only. The neural network is used, for example, independently. Alternatively, the neural network forms part of a higher-order neural network, in which, for example, the weights are non-binary. The higher-order neural network therefore has the neural network with the binary weights.

In the method, an input vector having different values is fed to each neuron. The number of values corresponds to the number of weights of the respectively assigned weighting vector. The values are designed as binary and therefore similarly have only two different configurations. These are, for example, 0 (zero) and 1, or preferably −1 and 1. The different configurations of the values therefore differ from one another only in terms of the sign. Here also it is possible to represent each of the values by means of a single bit only. At the start, for example, the values are binarized, in particular by means of a different method, or in an upstream work step. A comparison is thereby carried out, for example, with a threshold value in order to implement the two different configurations of the respective value.

The input vector and the weighting vector are processed with one another so that a transfer function is created. In other words, the input vector and the weighting vector are processed in order to obtain the transfer function. This function is also referred to as the propagation function. In particular, a vector multiplication is performed for this purpose. The scalar product of the weighting vector and the input vector is appropriately created.

The transfer function is processed with an activation function and a result is provided. This result is similarly binary, and the activation function is designed accordingly. The result therefore has only one of two configurations, which are appropriately −1 and 1. In particular, the binary result is subsequently used as one of the values of a different input vector which is fed to a different neuron, preferably any downstream layer. The values are exchanged between the layers, for example, in one direction only. In other words, the neural network is appropriately a feedforward neural network. However, it is also preferably possible for the result to be fed to the same layer or to a preceding layer. This represents the difference compared with a merely feedforward neural network and the neural network is appropriately a recurrent neural network. The neural network particularly preferably has recurrent components as well as feedforward components.

This is preferably carried out in each neuron of the neural network and, in particular, by means of the last layer of neurons, a complete result is provided, in particular a result vector or a specific result value.

Due to a design of this type, each weight, each value and each result are representable by means of a single bit only, and for this reason the memory requirement is comparatively low. The computing operations to be performed are also comparatively simple and their number is low so that, on the one hand, the provision of the result is accelerated, wherein hardware resources are reduced. On the other hand, the energy required for this purpose is reduced. Furthermore, no normalization is required and is appropriately not carried out, since only binary values/weights/results are used. The number of required computing operations is therefore also reduced for this reason, thereby further reducing hardware resources and the energy requirement. It is thus possible to design the hearing device as comparatively compact and lightweight, wherein manufacturing costs are not unduly increased. In particular, at least battery life is extended. Acceptance and therefore comfort for the user are consequently increased. The performance of specific functions or tasks of the hearing device is enabled by means of the neural network, so that accuracy in the performance and/or comfort for the user is/are increased.

The scalar product of the weighting vector with the input vector, for example, is created as the transfer function, for which purpose, in particular, each weight is multiplied by the respectively assigned value, and wherein the products created in this way are added together. However, the XNOR operation is particularly preferably used for this purpose, i.e., in particular, an equivalence function is performed. An XNOR gate is therefore appropriately used. Thus, instead of creating the product, a check is simply carried out to determine whether the respective weight is equal to the respective value. If so, one possible configuration is taken, and otherwise another possible configuration. In particular, the possible configurations of the weights and the values here are in each case −1 and 1, and either −1 or 1 is therefore similarly output as the result of the XNOR operation. A computing operation of this type is to be performed by means of software or hardware in a comparatively time-saving and resource-sparing manner, and no multiplication is required. The result of the XNOR operation is equal to the result of the product. Hardware resources and the energy requirement are therefore further reduced, wherein the same result is nevertheless obtained.

A comparison function, for example, is used as the activation function, and the transfer function is compared with a predefined limit value in order to obtain the result. If the transfer function is greater than said limit value, the one possible configuration, and otherwise the other possible configuration, is used as the respective result. Here, the limit value is, for example, random or it is preferably equal to 0 (zero). Only the sign of the transfer function is particularly preferably used as the activation function. If the transfer function is positive, the sign is 1, and otherwise −1. This corresponds essentially to the comparison with a limit value of 0, but wherein the processing is simplified. With the use of the sign, it is therefore simply necessary to read out the bit by means of which the sign is represented and use it as the result. Conversely, an explicit comparison with the limit value is not required. The number of required computing operations is therefore further reduced, and therefore the necessary hardware resources and the energy requirement also. In this way also, no subsequent normalization is required. Either 1 or −1 is appropriately used for the binary result.

For example, the input vector is determined, or created, using measurement data from a sensor of the hearing device. A motion sensor, for example, is used as the sensor. However, the input vector is particularly preferably created using captured audio signals, i.e., in particular, using a time sequence. The input vector corresponds, for example, directly to the audio signal or at least to the partially processed audio signal, at least in the first layer of the neural network. However, in the subsequent layers, the input vector is appropriately formed by means of the results of the respective preceding layer. However, these results are similarly based on the audio signal, so that the respective input vectors are created there also using the captured audio signal. This enables a current environment of the hearing device to be determined comparatively precisely by means of the neural network.

Alternatively, or particularly preferably in combination therewith, a forecast is produced for the future audio signals, in particular representing the output of the neural network, on the basis of the results, i.e., at least a part of the results, provided by means of the neurons, in particular the results of the neurons of the last layer of the neural network. In other words, the forecast is produced, in particular, on the basis of the result vector or the result value, or these elements correspond to the forecast. In summary, an assumption is made as to how the acoustic environment of the hearing device will change, in particular how a current sentence or word will be continued. In particular, the input vector is created on the basis of the captured audio signals for this purpose. In particular, an assumption is therefore made as to what the next syllable will be. Any signal processing unit is appropriately adapted on the basis of the forecast, wherein any processing of the captured audio signal is preferably modified. If the subsequent audio signal then corresponds to the forecast, comprehensibility is improved for the user. Since the neural network is, for example, a recurrent neural network, by means of which time sequences can be analyzed comparatively effectively, the accuracy of the forecast is, in particular, improved.

The precise design of the forecast/output preferably depends on the intended application of the neural network, but is preferably further processed by other components of the hearing device. The forecast/output is preferably used to influence the sound output on any receiver, whereby, for example, the network generates an estimation of speech components and interfering noise components in the audio signal, said estimation being used to set frequency-dependent amplification factors. Comprehensibility is improved for the user in this way. Since the neural network is a recurrent neural network, by means of which time sequences can be analyzed comparatively effectively, the precision of the distinction between speech and interfering noise is, in particular, improved.

With the above and other objects in view there is also provided, in accordance with the invention, a method that serves to train a neural network for a hearing device which has a plurality of neurons, and which, for example, is a recurrent neural network or at least has recurrent components. A weighting vector having binary weights is assigned to each neuron, at least when the neural network is fully trained. In the trained state, i.e., when the neural network is used, an input vector having binary values is fed to each neuron. The weighting vectors and input vectors are processed with one another in order to obtain a respective transfer function. The transfer function is processed with an activation function in such a way that a binary result is provided.

The method serves, in particular, to determine the weights. The method is carried out here, for example, by means of the hearing device itself, for example by a manufacturer of the hearing device. In this case, in particular, the hearing device is delivered with the already fully trained neural network. In the method, a plurality of training steps are carried out here, and, in particular, the weights are suitably adapted in each training step. The training steps are preferably carried out in temporal succession.

In each training step, the weights are appropriately first modified. This is done, for example, randomly, appropriately in compliance with certain specifications, or in a predefined manner. According to the method, the weights are first binarized. In other words, one of only two possible configurations is assigned to each weight. In other words, a digitization is performed, or a binary mapping of an existing weight onto one of the two configurations. However, one of the configurations is appropriately −1, and the other 1.

The binarized weights are normalized. It is thus ensured that all weighting vectors in this training step and/or in subsequent training steps always have the same norm, i.e., in particular, the same length. Each weight is multiplied by a respective normalization constant for the normalization. The normalization constant is the same here for all weights that are assigned to the same weighting vector. It is possible for the normalization constants assigned to different weighting vectors to differ from one another. In summary, each normalization constant applies, in particular, only to the weights which are assigned to the respective same weighting vector. The normalization constant is reciprocally proportional to the Euclidean norm of the respective weighting vector. In other words, each weight is divided by the Euclidean norm for this purpose, or the normalization constant comprises still further components. For example, a multiplication by a specific factor is additionally performed. The Euclidean norm corresponds, in particular, to the length of the weighting vector. However, since the weights are binary before the normalization, and are preferably equal to −1 or 1, the normalization constant is therefore equal to the number of weights of the respective weighting vector. The normalization constant is therefore always the same and is not dependent on statistics or the like, for which reason only few hardware resources are required to carry out the training.

The respective transfer function is then created for each neuron using the respective weighting vector, which is now normalized. For this purpose, the weighting vectors are processed with a fed-in input vector, wherein the weights do not simply have the configuration of −1 and 1 due to the normalization. In particular, the transfer function corresponds to the scalar product from the weighting vector and the fed-in input vector. The transfer function is then processed with the activation function in such a way that the binary result is provided.

This is preferably carried out for all neurons of the neural network, wherein, in particular, all neurons are used once per training step. Any result vector or result value is appropriately output by means of the neural network. A further value is preferably determined on the basis thereof and on the basis of a cost function. In the performance of the cost function, in particular, a comparison is made with a desired result vector/result value which, in the same way as at least some of the input vectors, is provided by means of training data.

Certain specifications, for example, apply in the choice of weights at the start of each training step. However, no specifications preferably apply here, and the weights can essentially be chosen randomly at the start, in particular at the start of the training, or in each training step. An already existing algorithm, in particular, can thus be used, thereby reducing the effort required. It is also possible to carry out the method comparatively efficiently on already existing hardware or software.

After the performance of the training steps, i.e. when, in particular, the provided result vector/result value matches the training data with sufficient precision, the weights are binarized and multiplied by the sign of the respective normalization constant. Thus, each of the weighting vectors then has the binary weights only. It is thus subsequently possible to use the weighting vectors directly to operate the hearing device.

The hearing device is, for example, a headset and, particularly preferably, a hearing aid. The hearing aid is, for example, a “receiver-in-the-canal” (RIC) hearing aid, an “in-the-ear” (ITE) hearing aid, an “in-the-canal” (ITC) hearing aid or a “complete-in-canal” (CIC) hearing aid, hearing aid glasses or a pocket hearing aid. Alternatively, the hearing aid is a “behind-the-ear” (BTE) hearing aid, which is worn behind an earlobe.

The hearing device preferably has a microphone. This is designed, for example, as omnidirectional, or it is suitably possible to modify a directivity characteristic of the microphone. For this purpose, the microphone preferably has two or more microphone units. Here, the microphone is suitable, in particular is provided and configured, for capturing an ambient sound. An audio signal is appropriately produced by means of the microphone when the ambient sound is captured. The hearing device appropriately has a signal processing unit which preferably has a signaling connection to the microphone. In particular, the audio signal is fed here to the signal processing unit during operation. The hearing device preferably comprises a receiver, by means of which the processed audio signal is output, and which appropriately has a signaling connection to the signal processing unit.

The hearing device further has a neural network having a plurality of neurons. The neurons are suitably divided here among different layers. The neural network is implemented, for example, simply by means of software, or the hearing device has dedicated hardware for this purpose, in particular a chip adapted thereto. The neural network is preferably assigned to the signal processing unit. The neural network is, for example, simply a recurrent neural network or simply a feedforward network. However, the neural network preferably has both recurrent and feedforward components.

A weighting vector having binary weights is assigned to each neuron, at least during normal operation. The hearing device is operated according to a method in which an input vector having binary values is fed to each neuron and is processed with the weighting vector in order to obtain a transfer function. The transfer function is processed with an activation function in such a way that a binary result is provided. Alternatively, or preferably in combination therewith, a method for training the neural network is carried out by means of the hearing device, for example once only, or during use, appropriately at specific time intervals. The weights are binarized and normalized here, for which purpose they are multiplied by a respective normalization constant which is reciprocally proportional to the Euclidean norm of the respective weighting vector. The respective transfer function is created for each neuron using the respective weighting vector, and the transfer function is processed with the activation function in such a way that a binary result is provided.

The signal processing unit is appropriately suitable, in particular is provided and configured, for carrying out at least partially one or both methods.

The developments and advantages explained in connection with the two methods are transferable accordingly to the hearing device and also with one another, and vice versa.

Other features which are considered as characteristic for the invention are set forth in the appended claims.

Although the invention is illustrated and described herein as embodied in a method for operating a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematically simplified view of a hearing device having a neural network;

FIG. 2 shows schematically the neural network having a plurality of neurons;

FIG. 3 shows a method for operating the hearing device;

FIG. 4 shows schematically a neuron; and

FIG. 5 shows a method for training the neural network.

Parts and elements that correspond to one another are denoted with the same reference signs throughout the figures.

### DETAILED DESCRIPTION OF THE INVENTION

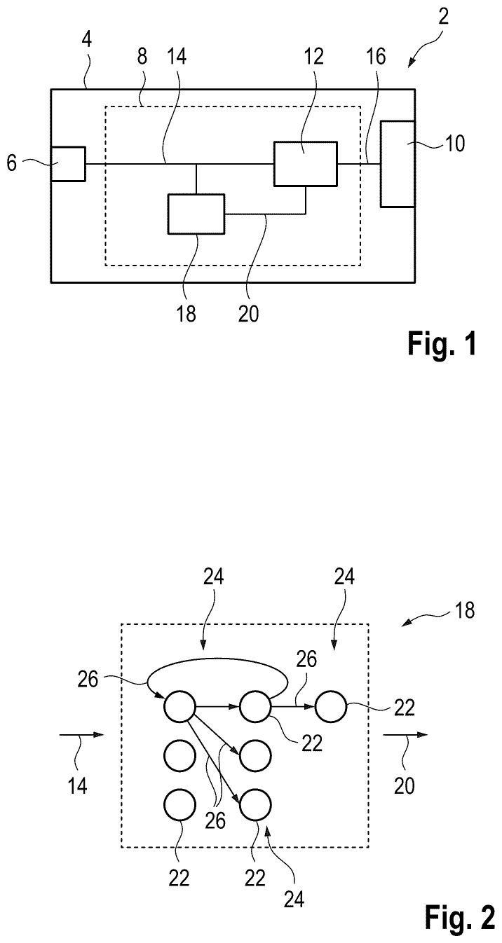

Referring now to the figures of the drawing in detail and first, in particular, to FIG. 1 thereof, there is shown a schematically simplified view of the hearing device 2. The hearing device 2 has a housing 4 within which a microphone 6 is arranged. The microphone 6 has a plurality of microphone units (not shown in detail), which are designed in each case as an electromechanical sound transducer or a capacitive sound transducer. A signal processing unit 8 is connected downstream of the microphone 6 for signaling purposes. A receiver 10, by means of which, during the intended use by a user, it is possible to output sound into an auditory canal of the user (not shown in detail), is connected downstream of the signal processing unit 8 for signaling purposes.

The signal processing unit 8 has a processor 12, or processing unit 12, by means of which an audio signal 14 provided by means of the microphone 6 during operation is processed, so that an output signal 16 is provided. A frequency-selective amplification and/or attenuation is performed here so that, for example, noise or other interfering sounds are suppressed. The processor 12 has, for example, a digital sound processor for this purpose. A compression, for example, is also carried out, so that a frequency spectrum of the output signal 16 is reduced in comparison with the audio signal 14. The output signal 16 is fed to the receiver 10 so that the sound output by means of the receiver 10 corresponds to the output signal 16.

The signal processing unit 8 further comprises a neural network 18, to which the audio signal 14 is similarly fed, and which has recurrent components. A forecast 20 for future audio signals is created by means of the neural network 18 and is fed to the processor 12. The processor 12 is set, i.e., in particular, amplification factors for different frequencies are selected, depending on the forecast 20. The processor 12 is set to the audio signal 14 which is probably temporally successive and is provided by means of the microphone 6 so that improved processing is performed. Comprehensibility is thus increased for the user in the sound that is output by means of the receiver 12. In summary, intermediate values which represent the forecast 20 and are useful for processing the audio signal 14 are calculated, in particular by means of the neural network 18, from the audio signal 14 and, for example, from other sensor data, e.g. acceleration values. The presence or absence of speech, for example, is estimated (“voice activity detection”).

FIG. 2 shows a schematically simplified view of the neural network 18. The neural network 18 has a plurality of neurons 22 which are assigned to different layers 24, wherein, in the example illustrated, three layers 24 are shown. By means of each neuron 22, a result 26 is provided which is assigned to the neurons 22 of the respectively following layer 24. However, it is also possible for one or more of the results 26 to be fed to one of the neurons 22 of the same layer 24 or one of the preceding layers 24. In the interests of clarity, FIG. 2 shows only some of the results 26. The audio signal 14 is assigned to the first of the layers 24, and the results 26 of the neurons 22 of the last of the layers 24 form the forecast 20.

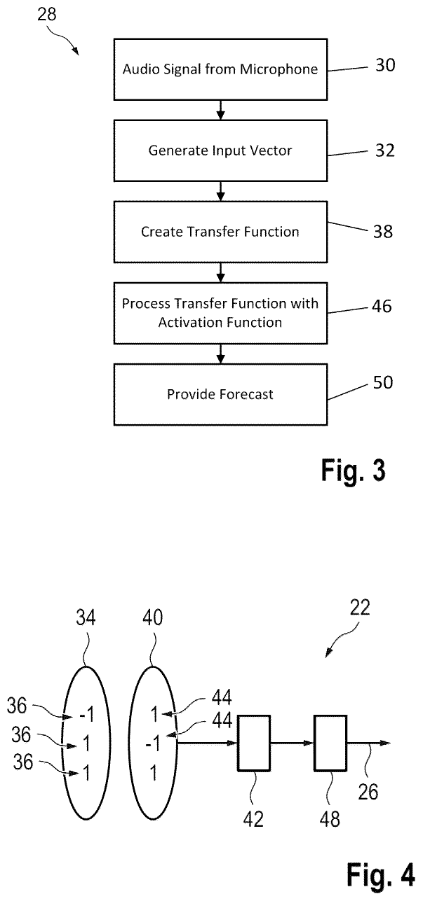

FIG. 3 shows a method 28 for operating the hearing device 2. In a first work step 30, the audio signal 14 is provided by means of the microphone 6. The audio signal 14 is fed to the neural network 18. In a subsequent second work step 32, an input vector 34 is created on the basis of the captured audio signal 14 and is fed to the neurons 22 of the first layer 24, wherein one of said neurons 22 is shown schematically in FIG. 4. The input vector 34 has a plurality of binary values 36, which are also referred to simply as values. The values 36 can assume two different configurations here, i.e. −1 and 1.

In a subsequent third work step 38, the respectively fed-in input vector 34 is processed with a weighting vector 40 assigned to the respective neuron 22, so that a transfer function 42 is created. In other words, the input vector 34 is processed with the weighting vector 40 in order to obtain the transfer function 42. The weighting vector 40 has a plurality of binary weights 44, which are also referred to simply as weights. Each binary weight 44 can assume only two configurations, i.e. either −1 or 1. The number of binary weights 44 is equal to the number of binary values 36 of the respectively fed-in input vector 34, and one of the values 36 is assigned in each case to each of the weights 44.

An XNOR operation is performed to create the transfer function 42. A check is carried out to ascertain whether the respective binary weight 44 is equal to the respectively assigned binary values 36. If they match, 1 is used as the result of the XNOR operation, and otherwise −1. The sum of the results corresponds to the transfer function 42. In summary, the sum of the XNOR operation

on all binary values 36 and the respectively assigned binary weights 44 is used as the transfer function 42.

In a subsequent fourth work step 46, the transfer function 42 is processed with an activation function 48 so that the respective result 26 is provided. The sign of the transfer function 42 is used as the activation function 48. The result 26 is thus similarly binary, and corresponds to 1 if the transfer function is positive, and otherwise to −1.

The results 26 of one of the layers 24 determined in this way are combined into the input vector 34 for the subsequent layer 24. Other results 26 are also added, if necessary, to the respective input vector 34.

The second to fourth work steps 32-46 are carried out for all neurons 22, in particular layer-by layer, or, if necessary, in a different sequence also. Since all results 26 are produced, at least indirectly, on the basis of the captured audio signals 14, all input vectors 34 are consequently created on the basis of the captured audio signals 14. The results 26 of the last layer 24 are finally combined into the forecast 20.

After the respective result 26 has been produced at least once by means of all neurons 22, a fifth work step 50 is carried out and the forecast 20 is output, on the basis of which, in particular, the processor 12 is then set. The audio signal 14 is then processed by means of said processor 12 according to the setting, so that the output signal 16 can be generated.

For the provision of the forecast 20, only 1 bit is required as memory space for each of the weights 44, and similarly only 1 bit is required as memory space for each of the values 36, compared with 8 bits if non-binary values/weights are used. The required memory space is thus reduced to approximately one eighth. A Boolean operation stored in a respective chip can be used in the performance of the XNOR operation, and no multiplication with a plurality of individual computing operations is required. Furthermore, no normalization is carried out, and only the bit assigned to the sign of the transfer function 42 is read out to perform the activation function 48. No computing operations are required here either. In summary, the forecast 20 is determined in a comparatively resource-sparing manner, for which reason the energy required to carry out the method 28 for operating the hearing device 2 is comparatively low.

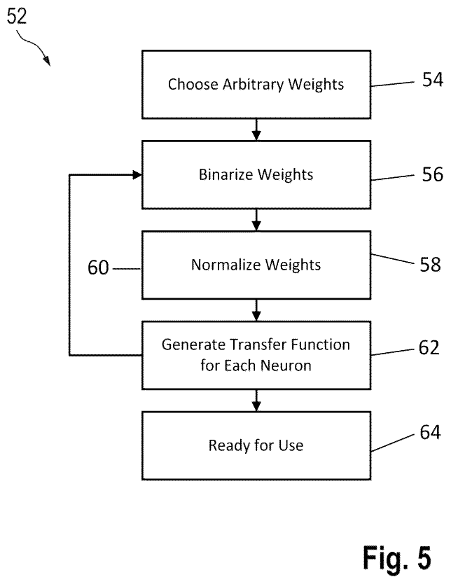

FIG. 5 shows a method 52 for training the neural network 18. This is carried out, for example, by a manufacturer of the hearing device 2, in particular before the hearing device 2 is made available to the user. Alternatively, the method 52 for training the neural network 18 is carried out by the user, for example at the start of use, or when the user had been using it already for a specific time period, for example one week or one month. In a further alternative, the method 52 for training the neural network 18 is carried out several times at specific time intervals. The method 52 for training the neural network 18 is carried out, in particular, by means of the hearing device 2 itself.

The method 52 for training the neural network 18 is started in a sixth work step 54. In this step, all weights 44 are first randomly chosen. In other words, there is no restriction in terms of the configuration, and the selection can be made from a continuous value range.

The weights 44 are binarized in a subsequent seventh work step 56. In other words, each weight 44 is mapped onto one of only two different configurations, in the example either onto −1 or onto 1. After the seventh work step 56 has been carried out, all weights 44 therefore have one of two different configurations. Insofar as the neural network 18 forms part of a higher-order network which is fully trained, it is possible for the higher-order neural network to have non-binary weights, but these do not form part of the neural network 18.

The weights 44 are normalized in a subsequent eighth work step 58. These weights 44 are multiplied by a normalization constant 60 for this purpose. The normalization constant 60 is the reciprocal of the Euclidean norm of the respective weighting vector 40. Since the weights 44 are either 1 or −1, the Euclidean norm corresponds to the number of weights 44 of the respective weighting vector 40. Each of the weights 44 is therefore divided by the number of weights 44 of the assigned weighting vector 40. The normalization constants 60 of different weighting vectors 40 differ from one another depending on how many results 26 are fed to the respective neuron 22, i.e. depending on the linking of the neural network 18.

In a subsequent ninth work step 62, the transfer function 42 is created for each neuron 22 by means of the respectively assigned weighting vector 40 which has the normalized weights 44. To do this, the corresponding input vector 34 having the binary values 36 is fed in each case to each neuron 22 and the scalar product is formed with the weighting vector 40. The input vector 34 that is used for the first layer 24 is provided by means of training data and has only binary values.

The respectively created transfer function 42 is processed on the basis thereof with the activation function 48 so that the binary result 26 is produced. If the transfer function 42 is positive, the value 1 is used as the result 26, and otherwise −1. This is performed for all neurons 22 so that the forecast 20 is created. This is compared with an expected forecast which is provided by means of the training data. The weights 44 are modified depending thereon, and the seventh to ninth work steps 56-62 are carried out once more. This is performed until the created forecast 20 matches the expected forecast with sufficient accuracy.

When this occurs, a tenth work step 64 is carried out. In this step, the weights 44, which can have different values due to the normalization last carried out in the eighth work step 58, are binarized, i.e. set to either −1 or 1. If the respective weight 44 is positive, 1 is used instead of −1. These are then multiplied by the sign of the respective normalization constant 60. Since the latter is always positive, a multiplication by 1 is therefore performed. Subsequently, each of the weighting vectors 40 then has only the binary weights 44, and the neural network 18 is trained and can be used to carry out the method 28 for operating the hearing device 2.

In one variant (not shown in detail), the binarization of the weights 44 is carried out only in the last repetition of the seventh work step 56 or only in the tenth work step 64. In this case, the value range for the weights 44 is preferably predefined in the seventh work step 56, so that they can, in particular, only be between −1 and 1, but wherein a plurality of configurations is possible. If the tenth work step 64 is carried out multiple times, the possible configurations then increasingly approximate either −1 or 1.

It will be understood that the invention is not limited to the exemplary embodiment described above. Instead, other variants of the invention can be derived therefrom by a person skilled in the art without departing the scope of the invention. In particular, all individual features described in connection with the exemplary embodiment are further combinable with one another in any way without departing the scope of the invention.

The following is a summary list of reference numerals and the corresponding structure used in the above description of the invention:
2 Hearing device
4 Housing
6 Microphone
8 Signal processing unit
10 Receiver
12 Processing unit
14 Audio signal
16 Output signal
18 Neural network
20 Forecast
22 Neuron
24 Layer
26 Result
28 Method for operating the hearing device
30 First work step
32 Second work step
34 Input vector
36 Binary value
38 Third work step
40 Weighting vector
42 Transfer function
44 Binary weight
46 Fourth work step
48 Activation function
50 Fifth work step
52 Method for training the neural network
54 Sixth work step
56 Seventh work step
58 Eighth work step
60 Normalization constant
62 Ninth work step
64 Tenth work step

1. A method of operating a hearing device, the hearing device having a neural network with a plurality of neurons each having a weighting vector with binary weights assigned thereto, the method comprising:
feeding an input vector having binary values to each neuron of the neural network and processing the input vector with the weighting vector in order to obtain a transfer function; and
processing the transfer function with an activation function to provide a binary result.

2. The method according to claim 1, which comprises using as the transfer function a sum of an XNOR operation on all values with a respectively assigned weight.

3. The method according to claim 2, which comprises using as the activation function a sign of the transfer function.

4. The method according to claim 1, which comprises creating the input vector on a basis of captured audio signals, and/or creating a forecast for future audio signals on a basis of the binary results.

5. A method for training a neural network, the method comprising:
providing the neural network with a plurality of neurons;
in each of a plurality of training steps:
binarizing a weight of each neuron;
normalizing the weights by multiplying a respective normalization constant which is reciprocally proportional to a Euclidean norm of the respective weighting vector;
creating a respective transfer function for each neuron using the respective weighting vector; and
processing the transfer function with the activation function to thereby provide a binary result.

6. The method according to claim 5, which comprises randomly choosing the weights at the start.

7. The method according to claim 5, after the training steps have been carried out, binarizing the weights and multiplying by a sign of the respective normalization constant.

8. A hearing device, comprising a neural network having a plurality of neurons, and being configured to be operated according to the method according to claim 1.

9. A hearing device, comprising a neural network having a plurality of neurons, and being configured to be operated according to the method according to claim 5.
